(19) United States
(12) Patent Application Publication
(10) Pub. No.: US 2006/0123634 A1
(43) Pub. Date: Jun. 15, 2006

(54) Scissors with handle opening overmold and ribbing

(76) Inventors: Michael E. Peterson, Fairfield, CT (US); Larry Buchtmann, Goldsboro, NC (US); Daniel Brady, Berkshire (GB); Stuart David Farnworth, Westport, CT (US)

Correspondence Address: WHYTE HIRSCHBOECK DUDEK S.C., ONE EAST MAIN STREET, SUITE 300, MADISON, WI, 53703-3300, US

(21) Appl. No.: 11/231,303

(22) Filed: Sep. 20, 2005

Related U.S. Application Data
(60) Provisional application No. 60/611,360, filed on Sep. 20, 2004.

(51) Int. Cl. B26B 13/00

(52) U.S. Cl. 30/232

(57) ABSTRACT

The present invention is a new and improved scissors having handle portions which include an overmolding and ribbing. The ribbing is positioned to increase the ease and comfort of use while also providing a cost effective and pleasing appearance.

### CROSS REFERENCE TO RELATED APPLICATIONS

This application claims priority under 35 U.S.C. § 119(e) from U.S. provisional application No. 60/611,360 filed on Sep. 20, 2004 and is incorporated herein in its entirety.

### BACKGROUND OF THE INVENTION

1. Field of the Invention

The present invention is related to cutting implements such as scissors. More particularly, the present invention is related to handles for cutting implements such as scissors.

2. Description of Related Art

Substantial effort has been expended in improving the construction and operation of stationery cutting implements for household and office use. Ever increasing demands have been placed on manufacturers of these products to increase the ease of use, the wear resistance, and the length of time in which the products can be comfortably used, while maintaining a competitive price. For example, typical household and office scissors have been unable to achieve a handle that conforms to a multitude of users' hands while reducing fatigue/increasing comfort and reducing the incidence of blisters.

It is known to manufacture scissors having steel blade members and integral steel handles or steel blade members and plastic handles. It is also known for scissors to have the plastic handles anatomically shaped to receive the user's fingers so as to maximize comfort and cutting control. Comfort in using the scissors depends not only on the shape but also on the extension of the surfaces of the finger-receiving holes that are contacted by the user's fingers. It has been found, however, that perfect adaptability of the handles by varying their shapes and dimensions is not possible due to the very variable characteristics of the hands of different individuals. One such example is the obvious difference between right-handed and left-handed persons.

U.S. Pat. Nos. 6,000,138 and 6,397,478 to Bornancini disclose handles for cutting instruments, where each handle is made of a relatively rigid plastic material and has a lining ring of elastically deformable material, such as natural or synthetic rubber, surrounding the finger-receiving hole portion. The elastically deformable ring permits the scissor handles to adapt to the fingers of the user, independently of their size or whether the user is right- or left-handed. However, these handles have a complex construction, requiring an element for anchoring the elastically deformable material of the rings to the rigid plastic material of the handle.

U.S. Pat. No. 6,493,947 to Stokes discloses handles for cutting instruments, where each of the handles has a forward portion formed as a rigid structure and a rearward portion formed from a form-stable but resilient and/or flexible material. The forward and rearward portions of the handle are separately formed and secured together by adhesive or fusion, or are co-molded together. While joining the forward and rearward portions together in this manner may provide a joint sufficiently strong to allow for light-duty use, it is questionable whether the joint would withstand extended use or heavy-duty use.

### BRIEF DESCRIPTION OF THE DRAWINGS

The present invention may be better understood and its numerous objects and advantages will become apparent to those skilled in the art by reference to the accompanying drawings in which.

FIG. 1 is an exploded view of a pair of scissors in accordance with the invention;

FIG. 2 is a front plan view of the scissors of FIG. 1;

FIG. 3 is a rear plan view of the scissors of FIG. 1;

FIG. 4 is side view of the scissors of FIG. 1;

FIG. 5 is a cross-sectional view taken along line 5-5 of FIG. 1;

FIG. 6 is a rear plan view of the handle segment of the second cutting member of FIG. 1, showing the outer layer removed; and

FIG. 7 is a front plan view of the handle segment of the first cutting member of FIG. 1, showing the outer layer removed.

### DETAILED DESCRIPTION OF THE PREFERRED EMBODIMENT

With reference to the drawings wherein like numerals represent like parts throughout the several figures, a pair of scissors in accordance with the present invention is generally designated by the numeral 10.

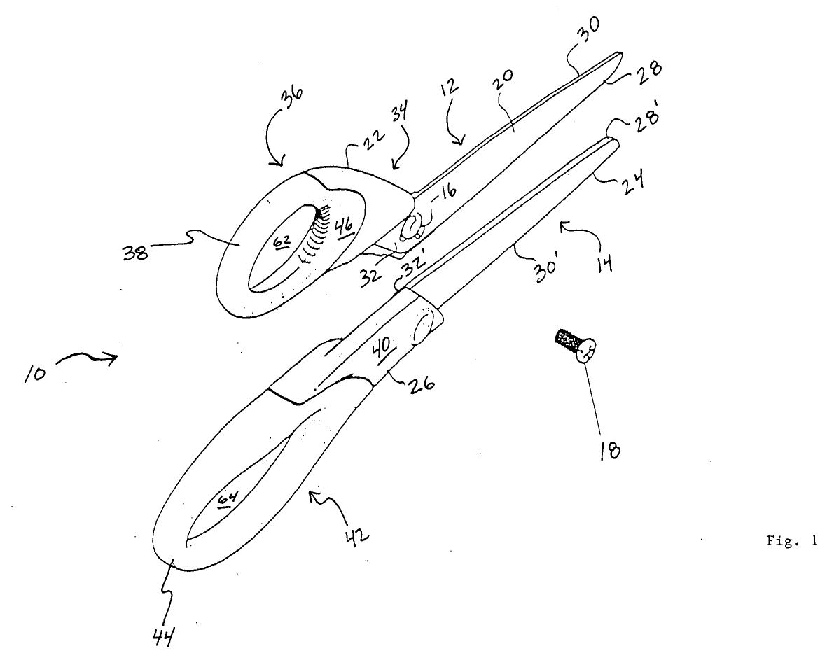

Referring to FIG. 1, the pair of scissors 10 has two cutting members 12, 14 pivotally connected together at a pivot point 16 by a bolt or screw 18. The first cutting member 12 has a forward blade segment 20 and a rearward handle segment 22 and the second cutting member 14 has a forward blade segment 24 and a rearward handle segment 26. The blade segments 20, 24 of both cutting members 12, 14 are composed of metal and include a cutting portion 28, 28′, having a single cutting edge 30, 30′, and a tang portion 32, 32′.

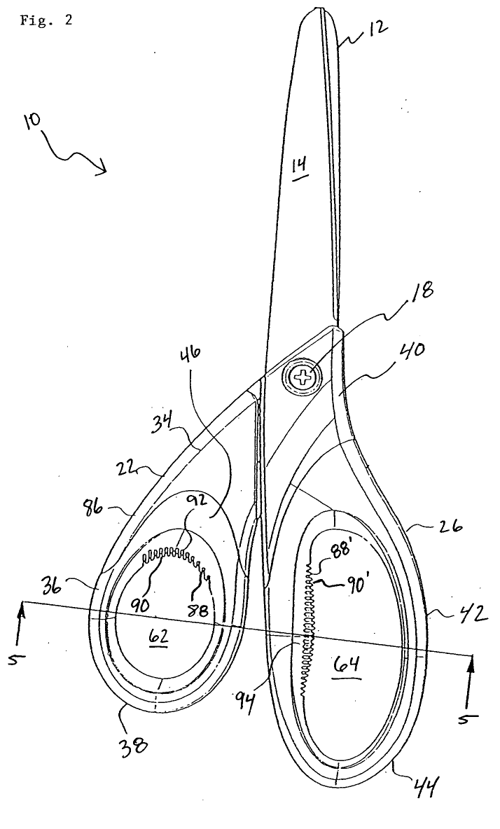

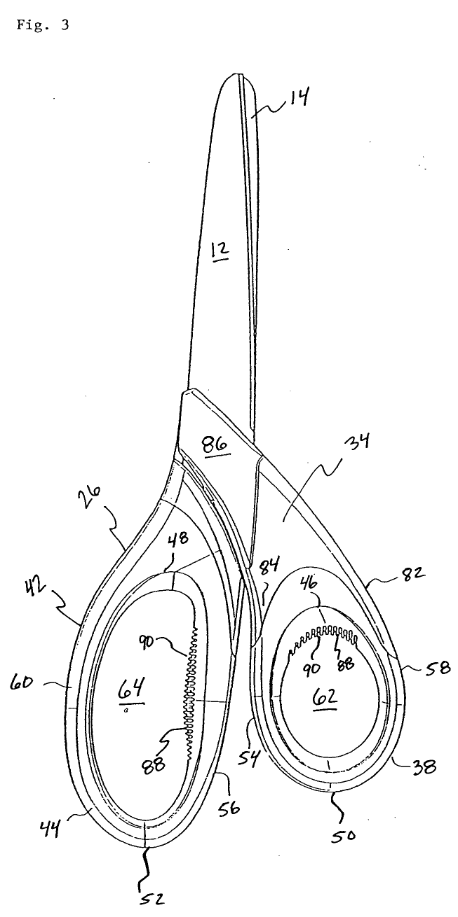

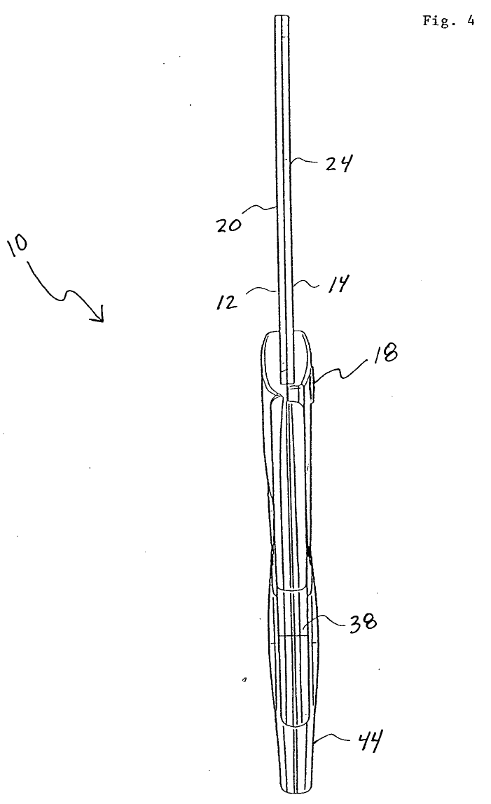

Now referring to FIGS. 2-4, the handle segment 22 of the first cutting member 12 has a front end portion 34 mounted to the tang portion 32 of the blade segment 20 and a rear end portion 36 forming the thumb bow 38. The handle segment 26 of the second cutting member 14 has a front end portion 40 mounted to the tang portion 32′ of the blade segment 24 and a rear end portion 42 forming the finger bow 44. The tang portions 32, 32′ of the blade segments 20, 24 are mounted to the front end portions 34, 40 of the handle segments 22, 26 and second by a fastener 18 for pivotal movement. As best illustrated in FIG. 3, the front end portion 34 has a smooth quasi-semi-cylindrical or convex shape so that the only exteriorly visible portions of the pivot fastening system is the head 18 or end of the fastener 18 as shown in FIG. 2.

The position of the blade pivot 16 and the structure of the handle segments 22, 26 which engage the blade segments at the extreme pivotal opening position of the scissor blades may be configured and to provide an opening angle of approximately 80° or greater.

The thumb and finger bows 38, 44 each have oppositely disposed forward portions 46, 48 and rearward portions 50, 52 and oppositely disposed inner portions 54, 56 and outer side portions 58, 60 that form openings 62, 64 that allow the passage of the thumb through the thumb bow 38, and several fingers through the finger bow 44. The thumb and finger bows 38, 44 each have a core 66, 68 formed from a rigid material, that may be a metal or an appropriate polymer material such as ABS, extending completely around the respective opening 62, 64. The front end portion 34, 40 of each handle segment 22, 26 is also formed from the rigid material, and is preferably formed integrally with the core 66, 68 of the bow 38, 44. A sleeve, or outer layer 70, 72 of resilient and/or flexible polymer material, such as TPE, envelopes the core 66, 68 of thumb bow 38 and the finger bow 44, forming the aperture or passageway for the thumb through the thumb bow 38 and the fingers through the finger bow 44.

Preferably, the sleeves 70, 72 are formed by overmolding the outer layer 70, 72 over the core 66, 68 of the thumb bow 38 and finger bow 44. The sleeves 70, 72 may also be formed by an injection molding procedure or any other similarly used process known in art.

It should be appreciated that deformation of the flexible outer layer 70, 72 caused by pressure exerted by the user's fingers creates a shear stress on the joint 74, 76 between the outer layer 70, 72 and the core 66, 68. The generally elliptical shape of the thumb and finger bows 38, 44 opposes any movement of the outer layer 70, 72 in the longitudinal direction that might separate the joint 74, 76. The forward, rearward, inner side and outer side portions 46, 50, 54, 58 of the thumb bow core 66 and the forward, rearward, and inner side portions 48, 52, 56 of the finger bow core 68 each have an eccentric, non-circular cross-sectional profile that opposes rotational movement of the outer layer 70, 72 around the core 66, 68 that might separate the joint 74, 76.

As shown in FIGS. 1 and 2, front end portion 40 has sides 78, 80. The side segments 82, 84 of the front end portion 34 of the first cutting member 12 may surround the forward portion 34 of the thumb bow 38. Similarly, one side segment 86 of the front end portion 40 of the second cutting member 14 may extend along the side 78 of the forward portion 48 of the finger bow 44. Such structure provides greater mechanical strength to the handle segment 22, 26 and also provides a decorative effect, especially if the rigid material and the resilient material are of contrasting colors.

As shown in FIGS. 1-3, alternating transverse ribs 88, 88′ and grooves 90, 90′ are provided in the portions of the surface of openings 62 and 64 that are generally engaged by the hand during cutting. More specifically, ribs 88, 88′ and grooves 90, 90′ are molded in the front surface 92 of the thumb bow opening 62 and the inside surface 94 of the finger bow opening 64. The ribs 88, 88′ and grooves 90, 90′ allow the use of a thicker grip and provide increased resiliency in these areas of contact, creating a cushioning effect that reduces pressure on the operator's fingers, thereby reducing fatigue/increasing comfort and reducing the occurrence of blisters. The increased resiliency also helps maintain finger contact and thereby provides greater cutting precision, facilitates use of either two or three fingers in the finger bow, and increases the suitability for use by either right handed or left handed users.

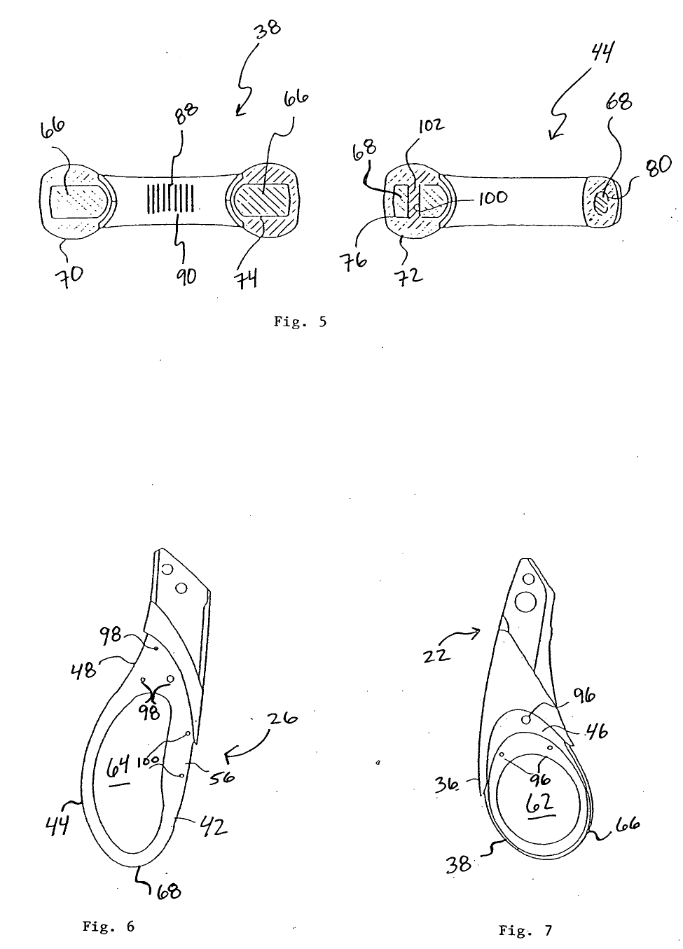

As shown in FIGS. 5-7, in addition, the forward portion 46 of the thumb bow 38 and the forward portion 48 and the inner portion 56 of the finger bow 44 have openings 96, 98, 100. When the outer layers 70, 72 are molded, the material flows through the openings 96, 98, 100, forming extensions 102 that connect the sides of the outer layers 70, 72, to further prevent the grips from peeling from the core 66, 68 and/or rotating about the core 66, 68. The smooth core/overmold interface facilitates the molding of the overmold.

It should also be noted that the terms “first”, “second”, and “third” and the like may be used herein to modify various elements. These modifiers do not imply a spatial, sequential, or hierarchical order to the modified elements unless specifically stated.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the disclosure without departing from the essential scope thereof. Therefore, it is intended that the invention not be limited to the particular embodiment(s) disclosed as the best mode contemplated for carrying out this invention, but that the invention will include all embodiments falling within the scope of the appended claims.

What is claimed:

1. A pair of scissors comprising:
a first blade assembly comprising a first blade connected to a first handle comprising a thumb opening, the first handle at a rearward portion being comprised of a core material and an overmold material molded over the core material, the core material having at least one extension opening, wherein the overmold material completely defines the thumb opening, wherein the overmold material forms extensions in the extension opening in order to prevent the overmold material from peeling from the core material;
a second blade assembly comprising a second blade connected to a second handle comprising a finger opening, the second handle at a rearward portion being comprised of a core material and an overmold material molded over the core material, the core material having at least one extension opening, wherein the overmold material completely defines the thumb opening, further wherein the overmold material forms extensions in the extension opening in order to prevent the overmold material from peeling from the core material; and
fastening means for pivotally joining the first blade assembly and the second blade assembly.

2. The scissors according to claim 1 further comprising a plurality of transverse ribs defining a portion of the thumb opening.

3. The scissors according to claim 1 further comprising a plurality of transverse ribs defining a portion of the finger opening.

4. The scissors according to claim 1 further comprising a plurality of transverse ribs defining a portion of the thumb opening and the finger opening.

5. The scissors according to claim 1 wherein the fastening means is exteriorly visible only at the exterior side surface of the first handle or the second handle.

6. The scissors according to claim 1 wherein the scissors may be pivotally opened to at least an 80° opening angle.

7. The scissors according to claim 1 wherein the core material and overmold material have a generally continuous smooth interface at the rearward portions.

8. The scissors according to claim 1 wherein the overmold material forms continuous sleeves about the core material of the first and second handles.

9. The scissors according to claim 4 wherein each of the first and second handles have greater than one extension.

10. The scissors according to claim 4 further comprising a plurality of grooves, wherein the grooves define a spacing in between the transverse ribs.

11. A pair of scissors comprising:
a first blade assembly comprising a first blade connected to a first handle comprising a thumb opening, the first handle at a rearward portion being comprised of a core material and an overmold material molded over the core material, wherein the overmold material completely defines the thumb opening;
a second blade assembly comprising a second blade connected to a second handle comprising a finger opening, the second handle at a rearward portion being comprised of a core material and an overmold material molded over the core material wherein the overmold material completely defines the finger opening;
a plurality of transverse ribs defining a portion of the thumb opening, wherein a plurality of grooves define a spacing in between the transverse ribs; and
fastening means for pivotally joining the first blade assembly and the second blade assembly.

12. The scissors according to claim 11 further comprising a plurality of transverse ribs defining a portion of the finger opening, wherein a plurality of grooves define a spacing in between the transverse ribs of the finger opening.

13. The scissors according to claim 11 wherein the scissors may be pivotally opened to at least an 80° opening angle.

14. The scissors according to claim 11 wherein the overmold material further comprises a first material and a second material, wherein the first material defines the finger opening and the thumb opening.

15. The scissors according to claim 11 wherein the fastening means is exteriorly visible only at the exterior side surface of the first handle or the second handle.

16. The scissors according to claim 12 wherein the transverse ribs are positioned to reduce pressure on a user's hand and maximize comfort for the user during use.

17. The scissors according to claim 14 wherein the first material is a flexible polymer material.

18. A pair of scissors comprising:
a first blade assembly comprising a first blade connected to a first handle comprising a thumb opening, the first handle at a rearward portion being comprised of a core material and an overmold material molded over the core material, wherein the overmold material completely defines the thumb opening;
a second blade assembly comprising a second blade connected to a second handle comprising a finger opening, the second handle at a rearward portion being comprised of a core material and an overmold material molded over the core material wherein the overmold material completely defines the finger opening;
a first set of transverse ribs defining a portion of the thumb opening;
a second set of transvers ribs defining a portion of the finger opening; and
fastening means for pivotally joining the first blade assembly and the second blade assembly.

19. The scissors according to claim 18 wherein the scissors may be pivotally opened to at least an 80° opening angle.

20. The scissors according to claim 18 wherein the first and second set of transverse ribs are positioned to reduce pressure on a user's hand and maximize comfort for the user during use.

21. The scissors according to claim 18 further comprising at least one opening in the core material of the first blade assembly and the core material of the second blade assembly, wherein the overmold material forms extensions through the openings.

22. The scissors according to claim 17 wherein the core material has an eccentric noncircular cross-sectional profile that opposes rotational movement.

23. The scissors of claim 18 wherein the fastening means is exteriorly visible only at the exterior side surface of the first handle or the second handle.
